(19) United States
(12) Patent Application Publication
(10) Pub. No.: US 2004/0027450 A1
(43) Pub. Date: Feb. 12, 2004

(54) Wide view, high efficiency, high resolution and clearer 3 dimensional image generators

(76) Inventor: Kazutora Yoshino, Eden Prairie, MN (US)

Correspondence Address: Yoshino, Kazutora, 226 N. Hillside Tr., Madison, WI, 53705, US

(21) Appl. No.: 10/356,875

(22) Filed: Feb. 3, 2003

Related U.S. Application Data
(63) Continuation of application No. 10/161,180, filed on Jun. 3, 2002.
(63) Continuation of application No. 10/235,575, filed on Sep. 5, 2002.
(63) Continuation of application No. 10/252,882, filed on Sep. 23, 2002.

(51) Int. Cl. H04N 13/00; H04N 15/00

(52) U.S. Cl. 348/42; 348/46

(57) ABSTRACT

By this invention, multi-users can view the very clear 3 dimensional objects or images in real time (run time) with wider angles of views, high efficiency, high resolutions without special glasses in the space or in the air due to the innovative image lifting device, fast frequency image refreshing rate 2 dimensional image display and its proper usage of the high speed image auto-focus means together with the methods of proper spacious separation and virtual plains. The device can capture the 3 dimensional images and display them in run time. Optionally, it can store the 3D image data. Also, one may use this device to manipulate 3D images.

### FEDERALLY SPONSORED RESEARCH

Not Applicable

### SEQUENCE LISTING OR PROGRAM

Not Applicable

### BACKGROUND OF INVENTION

1. Field of Invention

This is a continuation of the patent application of “Intelligent System and 3D virtual object generator” Ser. No. 10/161,180, “3 dimensional image projector and holodeck” Ser. No. 10/235,575 and “High resolution 3 dimensional image generator” Ser. No. 10/252,882. This invention relates to the image display devices, specifically to 3DTV, hologram, stereo display device that are used for displaying the 3 dimensional object or images and 3D scanners.

Recent development of 3D input device is amazing. Laser Design, Inc has developed the high-resolution 3D image input device to receive a 3D image. SONY & SONY KIHARA RESEARCH developed 3D image input device “Entertainment Vision Sensor” that can receive 3D images of 15 frames per second. As a result, the general market is asking a 3D image display to show 3D images as fast and clear as it can be received. The intension is to capture 3D images and recreate the 3D images. Optionally, storing the 3D image data would be a plus as well.

2. Description of Prior Art

In U.S. Pat. No. 3,647,284, (1970) Virgil B Ethlgs, et al. show the method of showing 3 dimensional images made by the light that was originally scattered by an object. This device put two dish means facing each other. The top dish means has a hole in the middle and 3 dimensional image shows up over this hole when user put the object at the bottom of the bottom dish means. But this device can lift only 3D image of real object by itself and therefore this device by itself would be unsuitable to show the real time (run time) 3 dimensional image. Also, this device can lift only 3D image of real object only in the same size of real object. The biggest problem of this method is the angle of view for the 3D image is very limited to certain angles only. People need much wider view of the image-lifting device.

U.S. Pat. No. 5,954,414, 1999, and U.S. Pat. No. 6,302,542, 2001, by Tsao indicates the method of making 3D image using a reciprocating motion of screen using deformable lens. But this does not mention practical way of making the “rapid” movement of screen. Also, the system of varifocal optical means is rather complicated and somewhat expensive. Another problems of all is that their varifocal optical means that is the deformable lens/curved mirror does not give satisfactory result for the practical purpose of 3D imaging. Especially when one needs more clear and precise 2D image projection on a screen? This is because deformable lens/curved mirror is very slow in response and accuracy is also very rough. Plus, deforming the lens/curved mirror creates a lot of stress and thereby it would be damaged or broken easily after thousands of times of imaging process. For example, when 50 images are presented in a second, deformable lens/curved mirror changes its form 50 times/sec. So it is 3000 times/min. and 180000 times/hr. According to what people tested so far, it is virtually impractical so far. Also, even though people like to view very clear 3D images, with his methods the 3D image tends not to be clear. This is because 2D images on a screen in his device tends to be not clear or not in focus due to the fact that the varifocal means does not show the practical way of how to keep those 2D images clear and in focus. And in practice, his method tends to have errors to focus those images for reasons like the time delay in response of varifocal means. Another problem of his method is that when the 3D image needs to be big, the system (screen, etc.) must be big as well. For example, if user need 14″ cubic 3D image, the screen must be 14″×14″ at least. This system including mechanical portion, if possible, is very difficult and expensive to make since the system must make reciprocating motion of 14″×14″ screen by 14″ of distance. In many cases, a screen tends to be bent by its inertia, air, etc. and the 3D image gets to be distorted. As a result, this is not a practical method for big 3D imaging system. Another problem of this device is that users cannot touch the 3D images. In many fields such as medical field and engineering field, users desire to have direct touch and interaction with 3D images. People expect flicker-free 3D display though 3D image with this a device tends to flicker since his device project 2D images in simple sequence. Although most important issue of 3D display devices in practice is how to transfer vast amount of 3D images data very fast especially if animation, his patent does not show any innovative way of fast speed data transformation for fast image display. Also, it does not show how to deal with such vast amount of data.

In U.S. Pat. No. 5,956,172 (1999) and U.S. Pat. No. 5,684,621 (1997) by Elizabeth Anne Downing, it shows the way to display the 3D image in a crystal. But user still cannot touch to the 3D image. Also, coupling (intersecting) two light beams is difficult and expensive in many cases since it needs to use more direction-specifying device such as galvanometers. Also, it is difficult and expensive to create big crystal used in these methods. Also, these methods do not show how to make full color 3D image. It may show only red, green and green color. One of problems of this system is that it is too expensive.

### OBJECTS AND ADVANTAGES

This invention has advantages relative to prior art in

1) It gives wider, clearer and brighter 3D images in the space even at the deep portions of image,

2) It gives higher resolution 3D images,

3) 3D images become very well controlled in depth resolution with fast response.

4) The cost efficient,

5) Energy efficient,

6) It looks like the 3D images are in the air.

7) It magnifies 3D image with high angle of views and clear images

### SUMMARY

In spite of the difficulties of prior art, by Virgil B Ethlgs, that could lift 3D image only in real size, we have developed the 3D image-lifting magnifier. Our 3D image lifting magnifier can lift 3D image meanwhile it magnify the original image. One of these examples has following features. It is made of the different shaped inside reflective surfaces. One looks like a dish with a hole. Another look like a mirror with some curvature added or flat mirror. When one put them together with proper distance with object or 3D core image, it would bring magnified object/3D core image up in the air. Additional lens such as sheet lens in the middle of the device allows user to view the image from the top as well. It creates much wider view of the 3D images and this is a very important feature for many applications. Also, our system can adjust the 3D image size and height having control on the position of 3D core image and the positions of the reflectors/lens.

In spite of the difficulties of the prior art by Tsao, we developed innovative system for 3D image display.

The recently developed image lifting and magnifying means together with the linear motion of 2D image generating means enables user to touch and interact with 3D images meanwhile the image lifting magnifying means can enlarge 3D core images in real time.

One of our ideas is to create the 3D core images in small volume, for example 2″×2″×2″, and magnify and lift the 3D images to 12″×12″×12″. Since the 3D core image can be small, 2D imaging projection can be made in telecentric/parallel image light optical system. This means that lays of light for the 2D image are parallel to each other so that 2D images on the moving plate in the different depth has the same scaling/size. The smaller size core image generator allows the reduction of the cost versus varifocal optical means and the general cost of the 3D core image generating means. Also it can create more controlled 3D images relative to the focus adjustable lens means.

But in the case that we need to make big 3D core images, we can also use the focus adjustable lens means such as piezo-electrical lens, electro-optical lens, acousto-optic lens does not physically move, they are practical for the usage of thousand times of image focusing process. Also, physically safe focus adjustable lens/mirrors may work as well. The example of these is speaker-like motion lens, lens with linear motion such as lens with linear motor, lens with linear actuator, lens with magnet & coil together with camera-like focus adjustable lens.

That is, in order to overcome the difficulties of the prior art of varifocal optical mean such as deformable lens/curved mirror, we made the system with the usage of

1) Auto-focus means like auto-focus video camera potentially including image sensor means and/or panel location sensor and/or lens location sensor and/or lens focus sensor together with devices like lens, magnet & coil, and piezo-electric lens, closed-loop focus adjustable lens means.

2) Telecentric/parallel image light optical system

There are many methods of autofocus means in U.S. patents. Also there are several methods developed by myself Here are examples of such methods.

One way of auto-focus means is to put sensors to measure the distances of the panel/screen and focus adjustable lens means, and to adjust the focus to the right focus determined by calculation based on the distance. This can be done by software or by hardware of electrical circuit or computer. Finding the right focus very fast automatically, the resultant 3D image becomes very clear.

Another way of auto-focus means is to measure the contrasts of different points of image and select the highest gradient/difference in the contrast as the image focus. For example,

1) 2D image projector projects 2D images to a screen.

2) Image/Photo sensor means measure the contrast of different points of the 2D image

3) Change the focus of the focus adjustable lens means to higher gradient of the contrast so that the image gets clearer.

4) By repeating the 2) & 3) find the optimal focal points of the image to get the optimal image clearness

5) Repeat 1) through 4) for a moving screen with proper 2D image projections for the clearest 3D images.

Image/Photo sensor can pick the center and its neighbor location(s) of the image to measure the contrasts.

Or image/photo sensor can measure the entire image and select the clearest image accordingly.

This can also be done by software or by hardware of electrical circuit or computer. Finding the optimal image clearness with auto-focus means, the resultant 3D image becomes very clear.

As examples, the focus adjustable lens means can be chosen from the combination of piezo-electric lens, electro-optic lens, acousto-optic lens, deformable lens/mirror, and speaker like motion lens next/in front of 2D display and synchronize the focus with 2D images so that entire image looks like 3D images. This is because virtual depth of 2D image is controlled by the focal length of focus adjustable lens means, by changing the focus, 2D images virtually move in depth. By changing 2D image and the focal length of focus adjustable lens means so fast that viewers perceive different depth of 2D images as 3D virtual image.

Also we apply the linear movement in more practical ways. One example is to move light thin panel/screen attached to a coil or coils with ferromagnetic pole (such as iron pole) with very strong magnet (1 Tesra or above for example) with the proper voltages. The coil moves linearly along the pole when the proper voltage is given by controller. This can be done in open loop circuit or closed loop circuit with (linear) encoder(s) or sensor(s). Another one is to use closed-loop servomotor or linear motors/actuators so that it can give very high precise motion. Linear motor can give the accuracy of 10 micro meter/step (Balder Motor) for example.

Also, in order to make the motion portion inexpensive and more efficient, we have a choice as followings. A magnet is connected to spring(s) and is next to coil(s) with ferromagnetic material (iron, etc.). The magnet is also connected to a pole with screen/panel/2D display. The system has a proper frequency omega, and by giving the frequency equal to or close to the proper frequency omega, the magnet and therefore the screen start oscillating with resonance. By the law of physics, the amplitude of the oscillation for the resonance becomes the maximum when the proper frequency omega is given to the coil. Because the movement is harmonic with this system, the small additional energy is required to get the oscillation going. That is, the energy efficiency of this system is high or it takes small amount of power to run this system.

Also, in order to make the motion practical, we need the moving screen/2D image panel to be light. One way is to use materials like thin plastic within the florescent chemical is doped or on which the florescence is painted. Thin plastic panel with thin plastic leg(s) which can be flat or properly curved with motion generating portion helps the structure strength of the moving portion together with the lightweight. This plastic panel can be clear with doped florescent chemicals for ultra violet light and/or for infrared light. Or simply this panel can be half clear/non-clear material like paper or white plastic.

Or oscillation of 2D image display such as LED, LCD or the organic EL panel would work as well.

Or instead of physical movement of the panel, the piled liquid crystals changing the depth on z-axis versus x-y 2D imaging can be used for the similar technique.

The recent development of high definition scanner led the development of FLC (ferromagnetic liquid crystal) and SLM (Spatial Light Modulator: sample by Boulder Nonlinear System), and DMD (digital mirror device) like DLP (Digital Light Processing: sample by Texas Instrument) technology that can project 2D image onto moving medium/plate/screen/scintillator/flourecent plate or moving organic EL display so fast that when the 2D images on 2D image generating means moves, it creates the 3D images. One key is how to create the projecting system with a high speed and a high resolution with a right field of depth together with mechanical practicality of linear motion or rotational motion. We can use servomotor, linear motor, actuator, etc. for linear/rotational motion to create the first enough motion of medium/screen. When 2D images are projected to medium/screen, we may use adjustable focus lens to synchronize the motion of the medium/screen to make clear image or we may use the parallel light images onto the linear motion of the medium/screen so that all 2D images on moving medium/screen are clear no matter where it is. We can use a white screen with mono-color/color projectors with visible light source. We can also use infrared light source and chemical doped crystals for the medium so that it shines when the infrared light source is projected. We can also use the Ultra Violet light source and scintillator for the medium so that projected 2D images on scintillator moves linearly/rotationally create 3D images. Scintillator is the medium/device such as plastic, glass, and gas with doped-chemical, such as florescent inorganic/organic materials, that shift the wavelength of light. Scintillator usually shifts the UV light to the colors such as blue and green color. If gas is used, it can be used to move the containing medium or the image light source in the gas can be moved to create the 3D images. Also, it is possible to put multi-layers of scintillators to make color displays. When the organic EL display (OEL display), Plasma display or 2D display with 2D images is moving linearly/rotationally, it would create 3D images as well. Or lens or reflectors are moving using the 2D images of such display can create the 3D images. Another key is how to transfer the data of 3D images efficiently. One can use the multi-threads with parallel processing CPUs for fast transferring data and/or simplification of the original data for 3D moving images. Also, it can save the 3D data information into RAM at first and keep sending the same data (repeating the same data) to create 3D still body images.

In order to generate the high resolution 3D images, our invention makes a screen move very fast (about 5 time/sec to 70 time/sec) having a projection from High definition SLM/DLP projector such as SLM of 512×512 resolution with 2 kHz 2D image refreshing rate or SLM of 256×256 resolution with 4 kHz 2D image refreshing rate from Boulder Nonlinear Systems. This can create 512×512×250 resolution of 3D images with about 8 times refreshing 3D images per second. This is because 512×512 resolution with 2 kHz=2000 Hz=250×8 Hz. This means that when a linearly moving medium/screen can have 8 times per second 3D images with z-axis of 250 resolutions. If this linear motion is simple reciprocal motion, 4 times going back and forth would give 8 times 3D image refreshing rates.

DLP (DMD) from Texas Instrument and PSI gives 2D images of 1000×786 resolution with 10 kHz binary signal. This means it can have 5-bit signal in 2 kHz. Advantage of this is currently more inexpensive than SLM with higher resolution.

GLV from SONY and Silicon Light Machine is the better choice if 2D image 1000×1000. MGLV is best choice in resolution and the speed. 1000×1000 resolution with 50 MHz.

Essentially the faster 2D refreshing rate would give clear 3D images with faster refreshing rates and better resolutions. Examples of the rough response time to signals are shown:

| | |
|---|---|
| SLM (FLC: ferromagnetic liquid crystal) | about 25 micro second |
| | (analog) |
| DLP (DMD: digital mirror device) | about 15 micro second |
| | (binary) |
| Organic EL display | about 10 micro second |
| GLV (grating light valve) (20 nano second | about 20 micro second for |
| for 1 line according to SONY) | 1000 resolution |
| MGLV (Matrix grating light valve) | about 20 nano second |

MGLV is parallelly arranged GLVs next to each other suggested by Kazutora Yoshino for faster speed of display. Since MGLV need no scanner for 2,3D image projection, the speed is much faster.

Note: Roughly speaking, 1/(response time)=2D image refresh max rate

Another idea is that by creating linear motion/reciprocating motion/rotation of 2D display such as organic EL display, plasma display itself can create the 3D images. This will give high resolution, virtually no flickering, bright and sharp 3D images.

Another idea is to make fluorescent chemicals radiate in proper wavelength given input wavelength particles such as photons. This can make full color 3D display. For example prepare 3 base color (Red, Green, Blue) radiating florescent components in liquid form, gas form, solid form, or mixed form with other components. If with proper wavelengths of input lights (UV light) are concentrated on the desired spot in the material, it radiate at the spot. Giving proper distribution of spots or scanning a spot creates 3D images. Or if this material is like a plate, linear movement of this plate with 2D image creates 3D images. Another way is, to create proper sequence of 2D image(s) inside of florescent material and give the linear movement to the 2D image(s) to create 3D images.

As for the image lifting device, the additional lens such as sheet lens (frunel lens), normal lens with proper magnitude, in the proper location in the middle of the 2 reflectors with curved or flat surface with the same magnitude of the 3D image enables for user to view the 3D virtual image from wide angles.

As for the data compactification, only “useful” information can be sent to the display. “Null” information can be treated by the controller. For example, each element of the core 2D image generating device such as DMD is ordered to be set zero most of the time. Proper elements would be turned on to “active” if “useful” information is given to them and it would be cleared in proper timing.

“Useful” information can be next image or the difference/difference of the next image from the current image. In general, if the object is continuous, the gradient/difference of the images has smaller data information. The initial 2D images plus the consecutive gradient 2D images can construct 3D images.

If the direct 2D image is given next each other, the clearing image should come at each image-refresh time. If the image gradients are given, element should latch the “active” state until next gradient signal comes in.

The proper spacious separation of 2D images with faster motion/switch of a screen can make the flickering of 3D images go away or at least it flickers in small space so that user feel more comfortable to view the 3D images.

The concept of virtual plain is to create the image plains between real plains. For example, if the a couple of 2D images are put next to each other closely in parallel and the intention of the each pixel is different, eyes view the 2 point lights as one point light and the location of the one point light is determined by the intensity of the pixel. By applying this to each screen, the “virtual plains” can be made. For example, intensity of 0.7 on a screen with intensity of 0.3 on the moving screen in the short time can create the virtual point with intensity of 1 at the location of the 70 percent of the small distance motion of the screen.

“FLC, DMD, GLV and MGLV”

### DRAWINGS

Drawing Figures

FIGS. (1-1-1), (1-1-2) & (1-2-1) shows the example diagrams of a 3 dimensional image generator with a z-axis generator, a projector, and image lifter/magnifier.

FIGS. (2-1-1), (2-2-1), (2-3-1) & (2-4-1) shows the other examples of diagrams of a 3 dimensional image generator with a z-axis, a projector, and image lifter/magnifier.

FIGS. (3-1-1), (3-1-2) & (3-2-1) shows the example diagrams of a 3 dimensional image generator with a z-axis generator, a projector, and image lifter/magnifier together with user-input-image device.

FIG. (4-1-1) shows the example diagrams of concept of virtual plains having multiple lights arranged so close that human eyes look it one light—a virtual point on a virtual plain. For example, if there are 2 of 2 dimensional images with proper intensities with proper short distance (properly short timed) on a moving plate, 3 dimensional virtual image can be made in this distance—called virtual plains. By having this on all sweeping space, it can have more virtual resolution in z-axis (depth/height) direction.

FIGS. (4-2-1), (4-2-2) shows the example diagrams of 3 dimensional image generation with properly timed & spaced 2D images for less-flickering effect. Optionally, by creating virtual plains between <1> and <1>′, it can have more virtual resolutions on z-axis.

FIG. (5-1-1) shows the example diagrams of a panel/screen motion generator with harmonic motion.

FIG. (5-2-1) shows the example diagrams of a panel/screen for at least two colors with UV light and infrared light.

FIGS. (5-3-1), (5-3-2) & (5-3-3) shows the example diagrams of (multi-color) virtual points, plains, and image with higher virtual z-resolution.

FIG. (6-1-1) shows the example diagrams of 3 dimensional image generator with 3D image input device. The 3D image generator can also be the 3D image generating 2D flat screen like the products made by SHARP (US patent).

FIG. (7-1-1) shows the example diagrams of schematics chart for the 3 dimensional image generator with 3D image input device.

FIGS. (8-1-1), (8-1-2),(8-2-1) & (8-2-2) shows the example diagrams of managing 3D image data efficiently having latching image system for the 3 dimensional image generator with 3D image input device.

FIGS. (9-1-1), (9-1-2), (9-2-1) & (9-2-2) shows the other example diagrams of managing 3D image data efficiently having handling only the difference/gradient between a new image and a previous image for the 3 dimensional image generator with 3D image input device.

FIG. (10-1-1) shows the example diagrams of temporal storage system of 3D image in order to have fast enough run-time 3D image data updating from computer(s).

FIG. (10-1-2) shows the example diagrams of general schematics/circuit of the 3D image data management.

FIGS. (11-1-1) & (11-1-2) shows the example diagram of 3D image input device.

### REFERENCE NUMERALS IN DRAWINGS

{1} 3D image generator

{2} 2D image generating panel/screen/display means such as plastic panel, paper with frame, glass, scintillator, plate with florescent chemical component, organic EL display, plasma display, FLC display, LCD, etc.

{3} Moving/Still 2D image generating panel/screen/display means such as plastic panel, paper with frame, glass, scintillator, plate with florescent chemical component, organic EL display, plasma display, FLC display, LCD, etc.

{4} Auto-focus & high-speed 2D Image projector means

{5} Focus Adjustable Lens means such as piezo-electric lens, electro-optic lens, acousto-optic lens, speaker-like driven lens, and mechanical optical lens.

{7} 3D core image

{8} Image lifting and magnifying means

{9} Lens means

{10} 3D image

{12} 3D core image generator means

{14} Support body

{15} Magnifying means such as sheet lens, normal lens, image lifting & magnifying means

{17} z-axis controller means such as open/closed-loop linear motor, servomotor, solenoid, actuator, coil with ferromagnetic rod with magnet with optional harmonic generator means such as spring(s) or rubber(s).

{20} Optional photo sensor(s)/image sensing devices/sensor(s)

{37} High-speed 2D image generator means such as digital mirror device (DMD), grating light valve (GLV), silicon light modulator (SLM), matrix grating light valve (MGLV).

{40} Laser means

{42} Light source means

{50} Input device means

{55} Image input and output means

{57} Image output device

{58} Image input device means

{70} Sensors

{71} Z-axis controller

{72} High-speed 2D display unit

{80} Controller means

{82} Z-axis driver

{83} Image driver

{88} Image data driver

{90} Computer means

{91} Video card means

{92} CPU means

{93} Other components

{94} 3D image data

{95} 3D image input device(s)

{100} 3D image input device(s), camera(s), motion sensor(s), sensor(s)

{200} Physical plane means

{202} Virtual plane means

{301} Physical plane means at t=t1

{302} Physical plane means at t=t2

{303} Physical plane means at t=t3

{401} Physical plane means at t=t1′

{402} Physical plane means at t=t2′

{403} Physical plane means at t=t3′

{501} Harmonic motion generator means

{502} Magnet/coil means

{503} Coil/magnet means

{505} Harmonic motion forcer means such as spring, rubber, magnetic spring

{507} Position/motion sensor means

{550} Device with 3D input device and 3D display such as cell phone

{551} Multiple 3D image input devices

{552} 3D image input device

{800} Database

{802} Data transfer & latch unit

{803} 2D image generator such as DMD/GLV/SLM/Matrix-GLV (MGLV)

{805} Automatic clearance unit

{807} Timer

{810} Input signal

{812} Latch & automatic clearance signal

{817} Timer signal

{900} Database

{902} Data transfer & latch unit

{903} 2D image generator such as DMD/GLV/SLM/Matrix-GLV (MGLV)

{907} Timer

{910} Gradient input signals

{912} latch & clearance

{917} Timer signal

{1000} Personal computer/Super computer/computing device

{1002} Temporal data store device

{1007} 3D display

### DETAILED DESCRIPTION

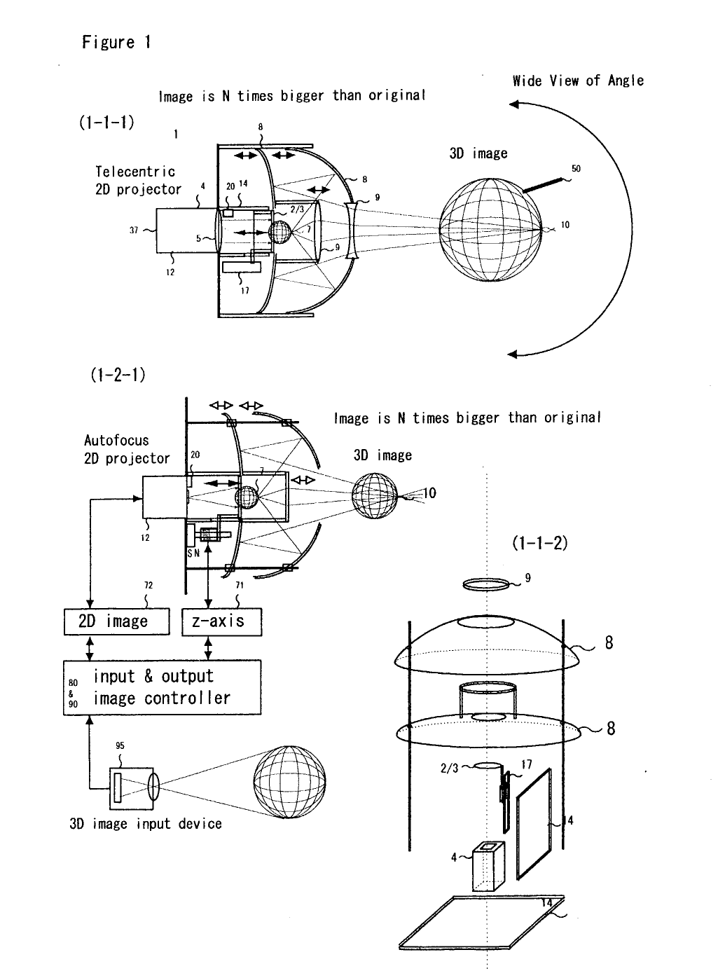

Description—FIG. 1: Preferred Embodiment

A preferred embodiment of the 3D image generator is illustrated in FIGS. (1-1-1), (1-1-2) & (1-2-1). FIGS. (1-1-1), (1-1-2) & (1-2-1) shows the example diagrams of a 3 dimensional image generator with a z-axis generator, a projector, and image lifter/magnifier.

Multiplication of 2D images generates the 3D core image. Multiplication can include linear motion of screen with 2D image or layers of panels with which 2D images are displayed. This can be done by various ways. Examples are the oscillation of a screen with 2D image projection, the oscillation of the 2D display, the focus-adjustable lens & 2D display, or layers of liquid crystals with 2D image projection. Linear motion can be made by z-axis controller means {17}. When 2D images are projected to a moving screen, high-speed 2D image projectors together with auto-focus mechanism {4} can be used to create the high-contrast clear 3D core image. When multiple photo sensors/image sensors {20} detect the contrast on the 2D image screen, by finding out the highest contrast of the 2D image, it can create the focused & clear images. Sensors and controllers measure the difference in the intensity of the 2D image at a point and its neighbor(s). By having focus adjustable lens co-linked to these sensors, the 2D images are focused at each step. Where highest gradient of those intensities between a point and its neighbor is the focus point. This can be done by measuring voltage input of one photo-sensor at a point or point(s) and its/those neighbor(s). By using comparator circuit or using software, it can determine the highest difference in the voltage, and therefore it can find the focus point. Examples procedures are the following:

1) Properly locate a panel/screen on z-axis

2) Project 2D image

3) Sense the 2D image (Detect the intensity/color of multiple <neighbor> points)

3) Modify the focus-adjustable lens until 2D image contrast is highest

4) REPEAT TO 1)

Other example is the following,

1) Properly locate the panel/screen on z-axis

2) Determine the location of the panel/screen using input devices such as (linear) encoder

3) Calculate the lens focus

4) Adjust the lens focus

5) REPEAT TO 1)

Auto-focus can be made by sensor/image sensing device to create the clear image {20} with focus-adjustable lens such as speaker-like motion generator with lens, rotation-like motion generator with lens, piezo-electric lens, electro-optic-lens. Or auto-focus can be done by Tele-centric imaging methods (create the parallel imaging). Or auto-focus can be made the motion generator with the high-speed 2D image generators: in this method, location of a reflecting devices such as digital mirror device (DMD), silicon light modulator (SLM), grating light valve (GLV), matrix grating light valve (MGLV) can be slightly moved to focus the images. By these methods, the 3D core image projector {12} produces the 3D core images. And the Image lifting and magnifying means lift and magnify the 3D core images. Addition of a lens to curved (or flat) reflectors with the same magnification will have user view the 3D image in the air with much wider view angles. A user can view the image from the top together with angled views. Also, by having the control on the positions of each part of the Image lifting and magnifying means, this device can display the 3D image of different size in different height of the user's choice. The control of the Image lifting and magnifying means can be mechanical/electrical/optical. The position can be manually modified or with controlling devices. 3D image inputting device {95} can be used to get the 3D image. The 3D image data can be organized in x-y-z coordinates. It can be sliced to the 2D images (x-axis & y-axis) data with height information (z-axis). The proper 2D image signals with modification if necessary can be sent the high-speed 2D image projector {12} through high-speed 2D image driver {72} and the height information can be sent to the z-axis controller {17} through the z-axis controller {71}. The 3D images can be simultaneously displayed to the 3D image generator or 3D images can be displayed after data has been stored in computer means {80}.

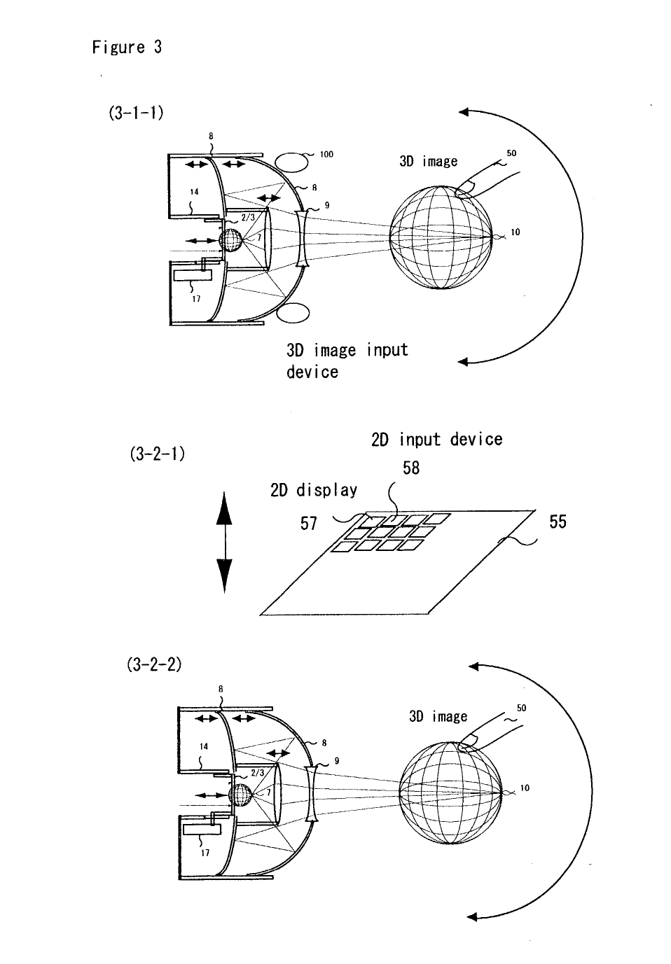

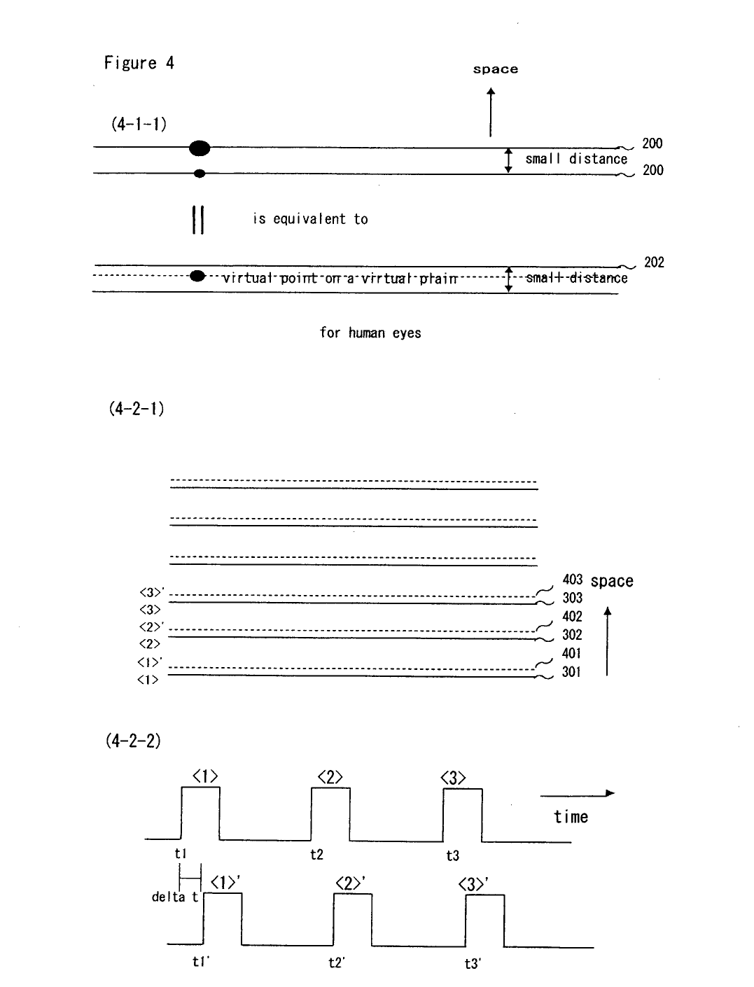

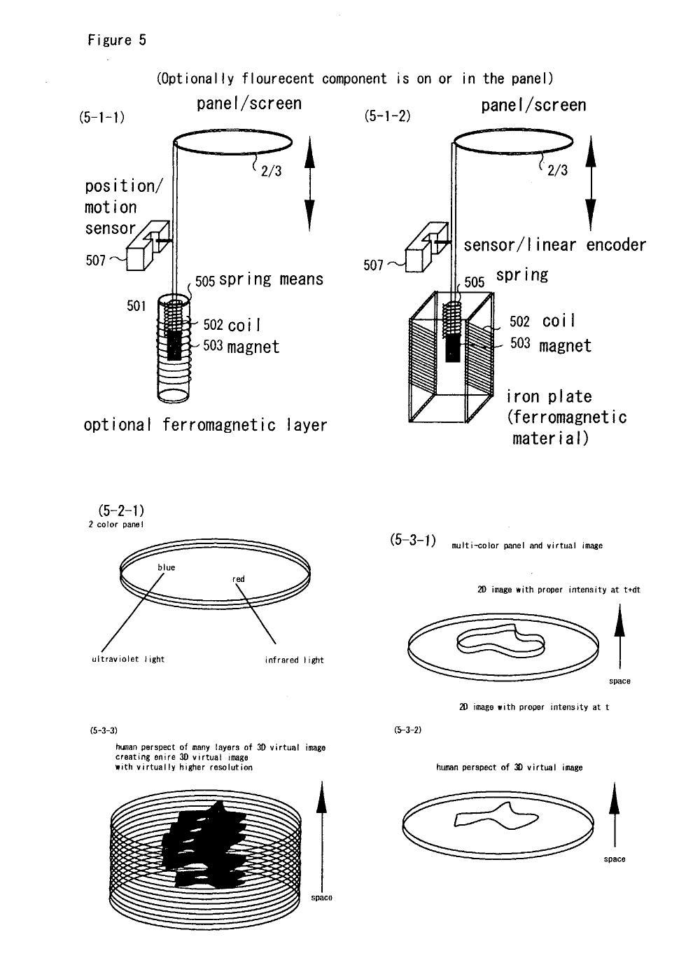

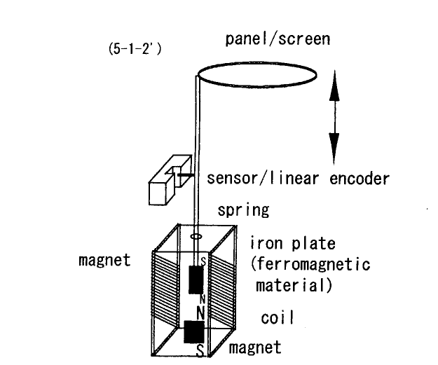

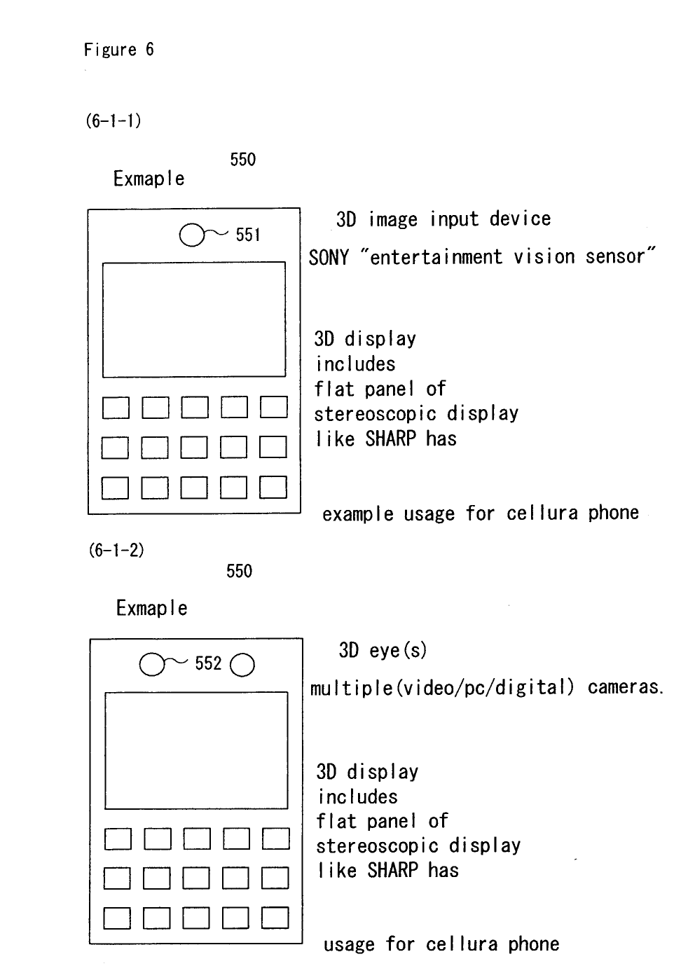

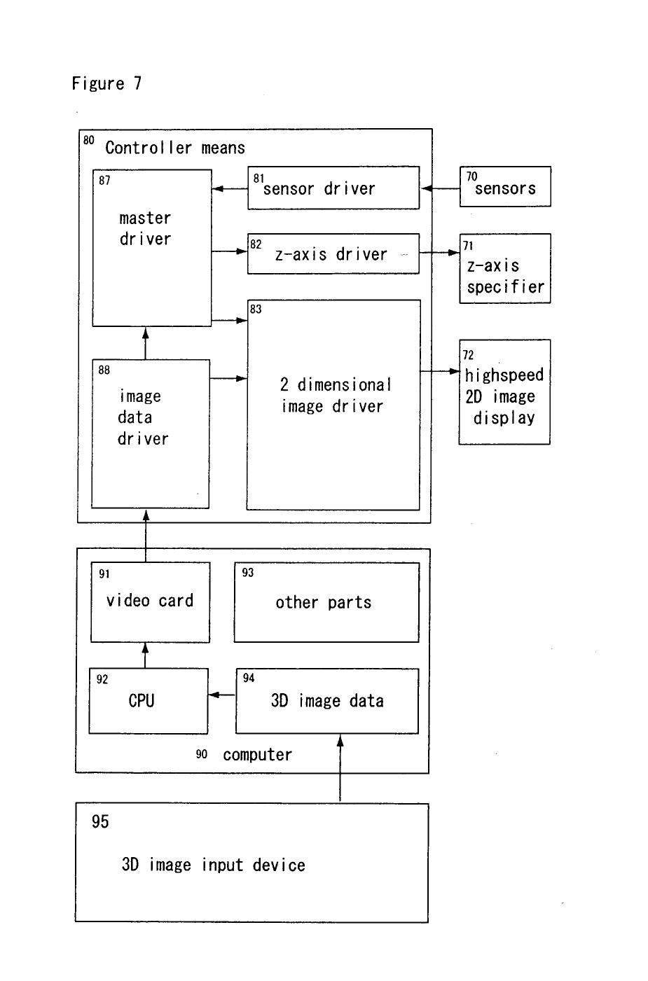

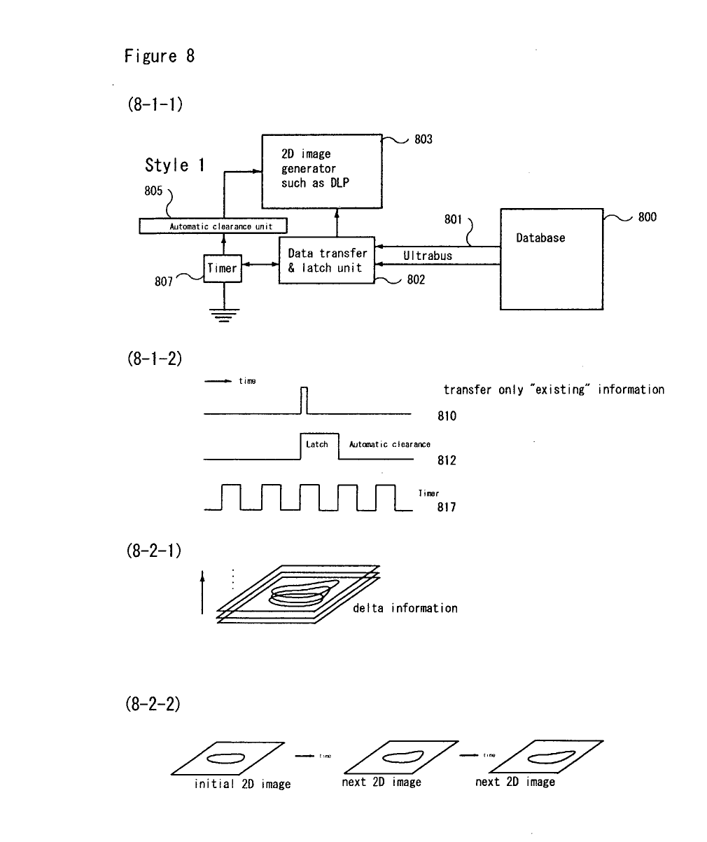

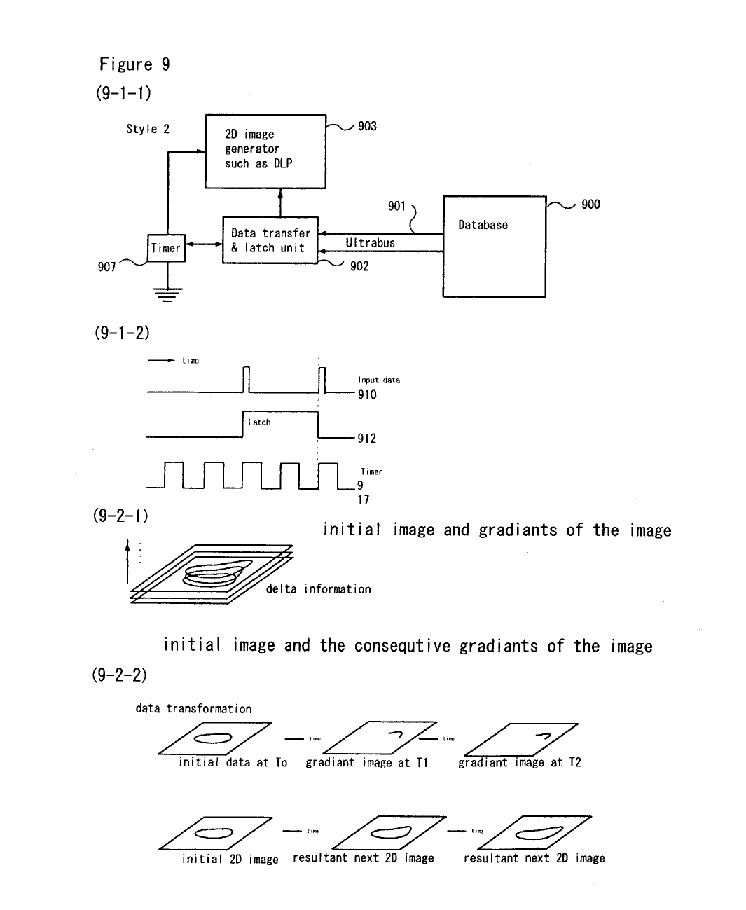

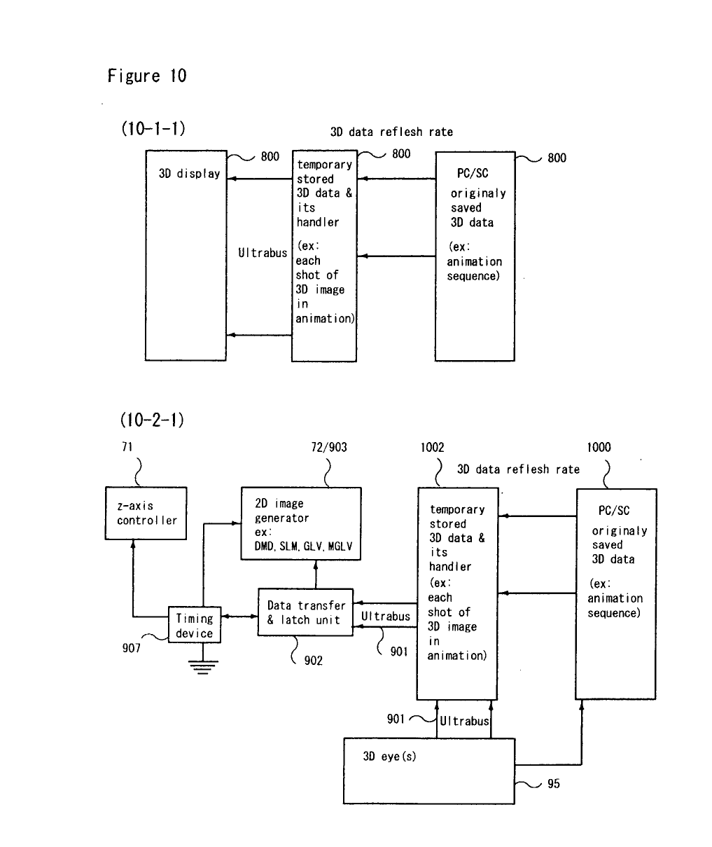

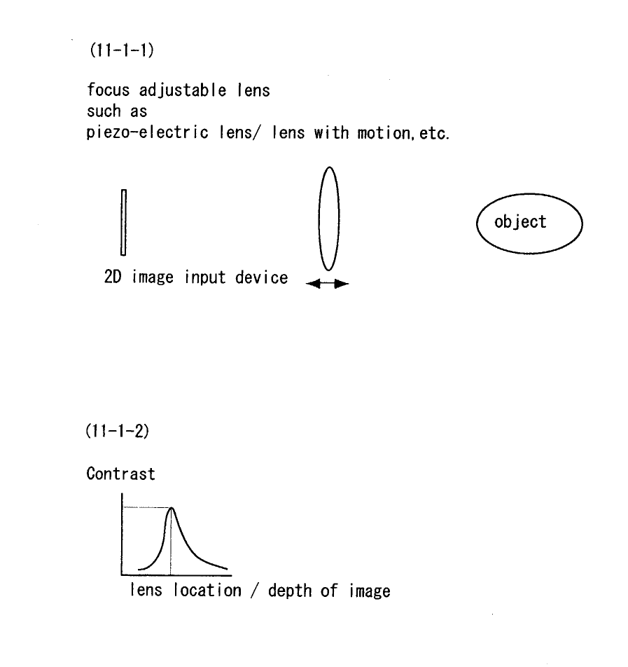

FIGS. 3, 4, 5, 6, 7, 8, 9, 10—Additional Embodiments

FIGS. (3-1-1), (3-1-2) & (3-2-1) shows the example diagrams of a 3 dimensional image generator with a z-axis generator, a projector, and image lifter/magnifier together with user-input-image device. (3-1-1) shows the diagram of the device that can understand the motion/location/shape of hand/fingers in 2D or 3D imaging environment through various input devices so that user can interact with the 3D image in the 3D display. Those input devices can be the 2D/3D image input device, sensor, camera, sensors {100}. (3-2-1) & (3-2-2) shows the method the image input device and display device is put next to each other and these are oscillated rapidly. By putting this together with the image lifting device (3-2-2), it enables the display the 3D core image and input the 3D image of the hand, input wand, input device, etc. Therefore it can co-relate the hand/wand, input device with 3D images displayed. Why it can input the image of hand/wand, input device is the same principle as the outputting image to lift except it is the opposite direction of light rays for input.

FIG. (4-1-1) shows the example diagrams of concept of virtual plains having multiple lights arranged so close that human eyes look it one light—a virtual point on a virtual plain. For example, if there are 2 of 2 dimensional images in physical plains {200} with proper intensities with proper short distance (properly short timed) on a moving plate, 3 dimensional virtual image can be made in this distance—called virtual plains {202}. By having this on all sweeping space, it can have more virtual resolution in z-axis (depth/height) direction. Or in general multiple layers of 2D images with narrow distance can create 3D images together with the fact that right/proper intensities on those layers can create virtual points between those narrow layers. So this gives virtually higher depth (z-axis) resolution of 3D image.

FIGS. (4-2-1), (4-2-2) shows the example diagrams of 3 dimensional image generation with properly timed & spaced 2D images for less-flickering effect. In general when 2D image is projected by sequence of next to each other, it creates a big flickering. So in order to overcome this difficulty, this may separate the 2D images in the proper spacing. This is also because higher speed 2D image refresh rate makes less flickering. By speeding up the 2D image shifting in depth (z-axis) and by spacing the 2D image (x-y axis) properly, it can have much clearer & cleaner 3D images. Also, by controlling the time in very small shit for the each 2D image projection, the virtual resolution of 3D image also increase. For example, when it displays 3D image at first with 2D images at z=1, 2, 3, 4 . . . and when it displays 3D image in next round with 2D image at z=1.1, 2.1, 3.1, 4.1 . . . using time shift of the starting point of 2D image projection, it is creating a virtual plane (resolution) next to the first 3D image. By repeating this time shift N times (with N division between separated distance), it can create N times higher virtual resolutions. This is important because high-speed 2D image projector has max speed so that if a device uses only same location, the 3D image resolution can be stuck within the speed of the 2D image projector. Meanwhile, timer circuit now days are much faster than 2D image projector and can control very small time spacing. Having our time shifting method, our invention can handle much higher virtual z-axis resolution for 3D images than the conventional methods. Also, optionally, by creating virtual plains between <1> and <1>′ discussed previously for the intensity distribution, it can have more virtual resolutions on z-axis.

FIGS. (5-1-1) & (5-1-2) shows the example diagrams of a panel/screen motion generator with harmonic motion. The idea here is many researchers had difficulties or creating a rapid reciprocating motion of a screen with long distance travel even though it is theoretically easy to say. In my lab, it is tested to move coil(s) that is mounted on a ferromagnetic pole such as iron pole attached to a magnet. By giving a different voltage it can move fast. An idea is to conserve the energy of motion to a direction and use it to reverse the motion, it is tested to use a spring/rubber at the ends of the pole for the reciprocating motion. By timing this coil motion with a proper circuit, it bounce back elastically at each end. Giving energy to fill the energy used for the friction, it gives quite efficient system for the fast reciprocating motion. (The magnet and the coil can be flipped. That is, a magnet can move in a coil.) Also, if energy need to be conserved even more efficiently, one proposal here is to put a coil connected to a harmonic oscillator generator means such as spring (/springs), rubber, magnetic-spring, electric-spring, and the coil is mounted on a ferromagnetic pole attached to a magnet. Or magnet with a harmonic oscillator generator means in a coil. By giving a force with frequency equal to or close to equal to the natural frequency (usually (k/m)\hat{ }0.5 where k is spring constant and m is the mass) of the harmonic oscillator generator means, the coil/magnet can move really fast (according to the natural frequency), energy-efficiently and quietly.

FIG. (5-2-1) shows the example diagrams of a panel/screen for at least two colors with UV light and infrared light. Or color light projected into a clear plastic can produce some imaging, too. Usually it is better if there are some chemicals doping in the plastic or fluorescent chemical painted on the plastic.

FIGS. (5-3-1), (5-3-2) & (5-3-3) shows the example diagrams of (multi-color) virtual points, plains, and image with higher virtual z-resolution.

FIG. (6-1-1) shows the example diagrams of 3 dimensional image generator with 3D image input device. 3D image input device(s) (1 eye/multiple) can capture 3D image data, and 3D display can show the 3D images. This can be use for devices like cellular phones.

FIG. (6-1-2) shows the example diagrams of 3 dimensional image generator with 3D image input device. The 3D image generator can also be the 3D image generating 2D flat screen like the products made by SHARP (US patent).

FIG. (7-1-1) shows the example diagrams of schematics chart for the 3 dimensional image generator with 3D image input device.

FIGS. (8-1-1), (8-1-2), (8-2-1) & (8-2-2) shows the example diagrams of managing 3D image data efficiently having latching image system for the 3 dimensional image generator with 3D image input device. Conventionally, full image data with full corresponding addresses are transferred for image device. But this takes way too much time for fast image projection technology. So, first only “existing” 3D image data {800} is transferred to Data transfer & latch unit {802} through ultra-bus {801}. “Existing” data means the data that would be actually displayed such as surface image of 3D object, and it is not the empty data. The ultra-bus is the parallel data transformation method or very high bits data transformation method. The only “existing image” information of image with its address (coordinate information) is transferred. The “existing image” information is allocated in proper addressed element of 2D image unit such as DMD/SLM/GLV/MGLV latched for a unit time. Those are automatically cleared in right timing. This allows the fast image refresh-rate.

FIGS. (9-1-1), (9-1-2), (9-2-1) & (9-2-2) shows the other example diagrams of managing 3D image data efficiently having handling only the difference/gradient between a new image and a previous image for the 3 dimensional image generator with 3D image input device. The image data {900} is converted to initial image data and the “gradient” data of each layer. Comparing 2D images next to each other, “gradient” data is produced. And the “gradient data” is transferred to Data transfer & latch unit {902} through Ultra-bus {901}. When the “gradient” data enters to Data transfer & latch unit, it latches the 2D image unit until it receives next gradient data. Initial data with “gradient” data next to each other can be reconstructed as 3D image data using this method. Because many of 3D objects are continuous topologically, this tends to reduce the transfer information and therefore, can have display 3D images much faster and more efficiently.

FIG. (10-1-1) shows the example diagrams of temporal storage system of 3D image in order to have fast enough run-time 3D image data updating from computer(s). When a computer is not fast enough to transfer entire information (3D image data), it stores to a temporal storage unit {1002}. The 3D projector displays the 3D image from the stored 3D data while it is loading the new 3D image data. In this way, inexpensive & slower personal computer, relative to super computer, can display 3D image in fair quality of animation.

FIG. (10-1-2) shows the example diagrams of general schematics/circuit of the 3D image data management. This is one example of construction of the circuit.

FIG. (11-1-1) shows the example diagram of 3D image input device. By picking up the highest contrast of neighbors of 2D image, it can auto-focus to the image. When a lens is moved and every 2D image in each step of motion are captured, by finding the highest contrast along points in 2D plane, it can find the focus point. Therefore, this can find the depth of the object (z-coordinate) at each point according to the location of the lens. If it takes the same procedure in each point on x-y coordinate, it can find the sets of x-y-z, that is, 3D data of the object. This means this method can be used as a 3D image input device. Similarly by changing the voltage on piezo-electric lens with observation of each 2D image can input the 3D images. This is important in the way that user can input large 3D image without projecting a laser light or slicing 3D objects.

FIG. (11-1-2) shows the graph of contrast with corresponding distance of lens and therefore the depth (z-axis) information at a point of (x, y) coordinate.

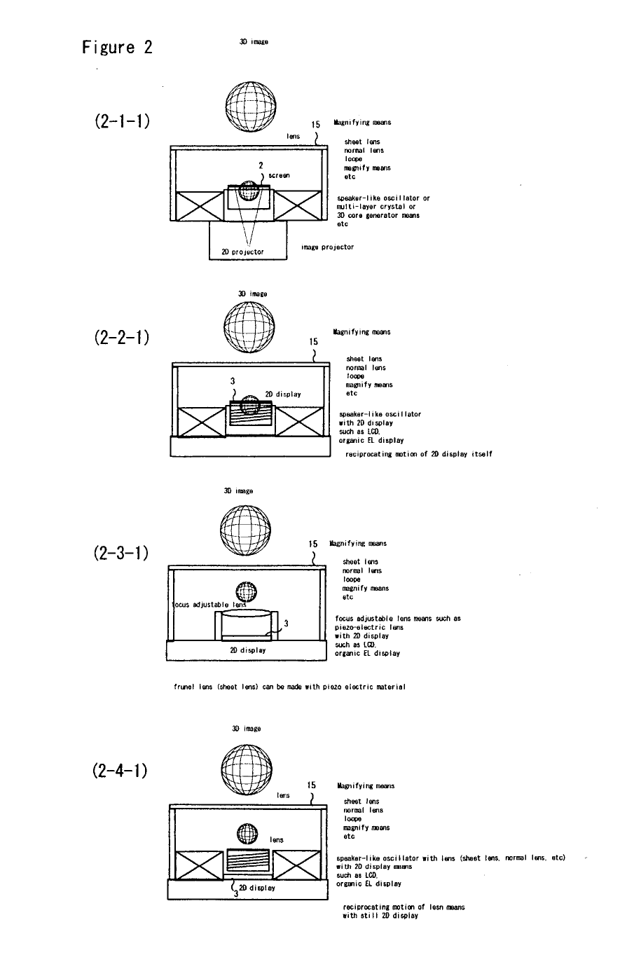

FIG. 2—Alternative and Other Embodiment—and Examples

FIGS. (2-1-1), (2-2-1), (2-3-1) & (2-4-1) shows the other examples of diagrams of a 3 dimensional image generator with a z-axis, a projector, and image lifter/magnifier. These presents the proper formations of the image magnifying devices and the 3D core image generators. Together with magnifying means such as lens, reflectors, (2-1-1) shows the moving screen with 2D image projection. Or, (2-2-1) shows the moving 2D display. Or, (2-3-1) shows the focus-adjustable lens with 2D display. Or, (2-4-1) shows the 2D display with moving lens.

Advantages

As mentioned, this invention has advantages relative to prior art in

1) It gives wider, clearer and brighter 3D images in the space even at the deep portions of image,

2) It gives higher resolution 3D images,

3) 3D images become very well controlled in depth resolution with fast response.

4) The cost efficient,

5) Energy efficient,

6) It looks like the 3D images are in the air.

7) It magnifies 3D image with high angle of views and clear images

Operation—FIG. 1, FIG. 2, FIG. 3

The image lifter and magnifier means and the input device enables user to interact with the 3D image directly. This has a good effect in many fields. Especially when a haptics system is added to get the feeling of touch of 3D image, it shows many applications in medical fields.

One example of the usage of the 3D image generator is in engineering field. Engineers can view the parts or how a designed system works in 3D and interact with them before constructing real objects. This helps a lot of researches in time and costs.

Another example of usage is that bioinformatists can design their proteins, drugs interfacing directly with 3D proteins/drug image by their hand, input device, etc.

One example is in the medical field, students/doctor can practice virtual operation many times using this device/system having a feeling touch of 3D image of patient's organs, teeth, and brains, infant in a mother of humans, lungs. The 3D data acquired from ultrasound scanner, CT scanner, X-rays, MRI, diffusion MRI can be sent to the 3D image generator. Doctors can look at the progress of the infants' growth in mothers' body in 3D form including their organs, which can help doctors to judge/diagnose/give a lot of treatments to the infants who is born yet. In recent years, most of brain image by MRI is pictured in sequence of the 2D pictures. Often, the pictures are flipped and doctors make incorrect decisions. These types of problems are a big problem in medical field and need to be fixed. Since the 3D image generator can give the 3D image directly, it can reduce the problem such that. Also the family/patient can understand what is happening more clearly when doctors need to explain it. It helps the efficiency of the medical care. Also, 3D image generator allow doctors to view the patient brain in 3D so that s/he can visualize and judge the distance of section for operation much simpler and best of all s/he can practice the operation of the patient's brain many times before actually operating the patient's real brain. From the words of doctors we know of this 3D image generator can bring a revolution in medical field.

### CONCLUSION, RAMIFICATIONS, AND SCOPE

By this invention, multi-users can view the very clearer and flicker-free 3 dimensional objects or images in real time (run time) with wide angle of view, high transverse resolution and depth resolution without special glasses in the air.

I claim:

1. The three dimensional image generator means that creates three dimensional images comprising the devices selected from the group consisting of
1) two dimensional image generating panel means
2) two dimensional image panel motion generator means
3) auto-focus two dimensional image projector means
4) three dimensional image data controlling means
5) optionally, image lifting and magnifying means
6) optionally, input device means

2. The invention of claim of [1], wherein said two dimensional image generating panel means is composed of the components from the group consisting of
plastic screen, paper screen, glass screen, film, organic material screen, inorganic material screen, crystal, plasma gas, gas with container, liquid with container, solid material, superconductors,
lens,
organic el display, plasma display, ferromagnetic liquid crystal display, liquid crystal display, high frequency two dimensional display.

3. The invention of claim of [1], wherein said two dimensional image panel motion generator means is composed of the components from the group consisting of
open-loop or closed-loop motion generators such as
harmonic motion generating means comprising the components from the group consisting of magnet, coil, spring, pole, and location sensor and/or motion sensor,
or simple reciprocating motion generating means comprising the components from the group consisting of
linear motor, linear actuator, magnet and coil actuator, solenoid, ultrasound motor, servo motor, direct-current motor, alternative current motor, engine, bearings, air bearings,
support of said two dimensional image generating panel means and controllers of said motors.

4. The invention of claim of [1], wherein said auto-focus two dimensional image projector means is composed of the components from the group consisting of
1) two dimensional image generator means
2) image sensor means
3) focus adjustable lens means
4) optionally, lens position sensor and/or lens motion sensor
5) optical instrument means
6) power
7) auto-focus controller means

5. The invention of claim of [4], wherein said two dimensional image generator means is composed of the components from the group consisting of
ferromagnetic liquid crystal display, liquid crystal display, spatial light modulator, digital light processor, grating light valve with scanner, matrix grating light valve, two dimensional grating light valve, organic el display, plasma display.

6. The invention of claim of [4], wherein said optical instrument means is composed of the components from the group consisting of
lens means comprising lens, concave lens, convex lens, sheet lens, optical lens, and magnet lens
reflector means comprising mirrors, curved mirrors, parabola like mirror, and part of sphere like mirrors
focus adjustable lens means

7. The invention of claim of [6], wherein said focus adjustable lens means is composed of the components from the group consisting of
piezo-electric lens, electro-optic lens, acousto-optic lens, speaker-like driven lens, linear motor driven lens, actuator driven lens, magnet and coil driven lens, and mechanical optical lens.

8. The invention of claim of [4], wherein said image sensor means is composed of the components from the group consisting of
image sensors, photo sensors, arrays of photo sensors, matrix arrays of photo sensors, electric image sensors.

9. The invention of claim of [4], wherein said auto-focus controller means is composed of the components from the group consisting of
computer hardware, software to calculate the optimal focus point of said focus adjustable lens means for two dimensional images.

8. The invention of claim of [1], wherein said three dimensional data controlling means
is composed of the components from the group consisting of
three dimensional image compacting means
virtual plain generating means
three dimensional image right separation handling means
self-adjusting update image controller means

8. The invention of claim of [1], wherein said image lifting and magnifying means is composed of the components from the group consisting of
size and location adjustable image lifting and magnifying means comprising
position adjustable means comprising the components from the group consisting of poles, gears, stoppers, motors, nobs,
image operation means comprising the components from the group consisting of
curved or flat reflective mirrors, curved or flat reflective mirrors with holes, parabola mirrors with holes, a part of sphere shape reflective mirror with hole and
lenses, lens means.

9. The invention of claim of [1], wherein said input device means is composed of the components from the group consisting of
three dimensional image input device means,
user input device means comprising
ultra-sound position and orientation tracking devices, electro-magnetic wave position and orientation tracking devices, haptics system, infrared position and orientation tracking system, and position-orientation-motion monitoring system

10. The invention of claim of [9], wherein said three dimensional image input device means is composed of the components from the group consisting of
triangular method three dimensional image input device,
mesh method of three dimensional image input device,
focus adjustable lens method of three dimensional image input device means,
devices that can input the data of three dimensional images and objects.

11. The invention of claim of [10], wherein said focus adjustable lens method of three dimensional image input device means, is composed of the components from the group consisting of
two dimensional image capturing unit
focus adjustable lens
measuring device of focal length of the focus adjustable lens, such as potentiometer, encoder, voltage meter, optical focal length measuring device, measuring devices
computing device to calculate the depth of each points of object

12. The virtual resolution three-dimensional image generator means comprising the components selected from the group consisting of
device with intensity method of virtual resolution generating means
device with spacing method of virtual resolution generating means
optional image lifting and magnifying devices means comprising the components selected from the group consisting of reflectors, lens, position adjuster, mirage generator

13. The invention of claim of [12], wherein said device with intensity method of virtual resolution generating means is composed of the components from the group consisting of
layers means, such as a moving screen, shifting layers, layers of optical screens
intensity divider to said layers means for virtual point location
high speed image projector

14. The invention of claim of [12], wherein said device with device with spacing method of virtual resolution generating means is composed of the components from the group consisting of
layers means, such as a moving screen, shifting layers, layers of optical screens
space divider to said layers means for virtual point location
high speed image projector

15. The high-speed three dimensional image generator means comprising the components selected from the group consisting of
high-speed two dimensional image generating unit means
high-speed data handling method and device means
z-axis controller
auto-focus optical device
optionally, image input device

16. The invention of claim of [15], wherein said high-speed two dimensional image generating unit means is composed of the components from the group consisting of
digital mirror device, silicon light modulator, grating light valve, matrix grating light valve, galvanometers, acousto-optic deflector, electro-optic deflector, and two dimensional image generating device

17. The invention of claim of [15], wherein said high-speed data handling method and device means is composed of the components from the group consisting of
database means, ultra-bus, data transfer and latch unit means, timer, image producing unit, automatic data handling unit, temporal data storing unit, useful-data-converter means

18. The invention of claim of [17], wherein said database means is composed of the components from the group consisting of
random access memory, hard drive, central processing unit, data storage unit, internet

19. The invention of claim of [17], wherein said data transfer and latch unit means is composed of the components from the group consisting of
proper signal holding device, latch, flip-flop, logical circuit

20. The invention of claim of [17], wherein said useful-data-converter means is composed of the components from the group consisting of
three dimensional data slicing device,
data comparing software, data comparing hardware, image gradient data generating device, unit to eliminate null data
useful data and address coupling device
